(19) United States
(12) Patent Application Publication
(10) Pub. No.: US 2025/0137827 A1
(43) Pub. Date: May 1, 2025

(54) PORTABLE LIQUID DISPENSER

(71) Applicant: Katharine Alice Oliver, Atlanta, GA (US)

(72) Inventor: Katharine Alice Oliver, Atlanta, GA (US)

(21) Appl. No.: 18/933,001

(22) Filed: Oct. 31, 2024

Related U.S. Application Data
(60) Provisional application No. 63/595,159, filed on Nov. 1, 2023.

(51) Int. Cl. G01F 11/08

(52) U.S. Cl. CPC G01F 11/08

(57) ABSTRACT

A portable liquid dispenser includes a housing assembly with a housing and adapter, a liquid-containing cartridge removably connected to the adapter, and a displacement assembly positioned within the housing assembly. The displacement assembly has a compressible chamber with proximal and distal ends, a proximal valve connected to the proximal end, and a distal valve connected to the distal end. A nozzle is slidably connected to the housing. The displacement assembly transitions between a first position and a second position to displace a dose volume of liquid from the cartridge through the nozzle. The compressible chamber may have one or more annular ribs around its circumference. The housing may have air holes to permit air exchange. The nozzle may be asymmetrical with a dispensing tip and grip. The valves may be one-way umbrella valves. Connections between components may be tapered threaded connections providing a fluid-tight seal.

### RELATED APPLICATION

Under provisions of 35 U.S.C. § 119(e), the Applicant claims benefit of U.S. Provisional Application No. 63/595,159 filed on Nov. 1, 2023, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to liquid dispensing devices. More specifically, it pertains to portable, manually-operated liquid dispensers for accurately delivering preset dose volumes.

### BACKGROUND

Liquid dose administration can be an inaccurate, difficult, and unhygienic process, presenting challenges to users in diverse settings, such as laboratories, medical clinics, veterinary clinics, personal home use, and construction. Liquid dispensers of the prior art often require that liquid remains in a chamber in between dispensing cycles, leading to leakage and inaccurate dose delivery.

Some liquid dispensers require careful measuring to deliver accurate doses and significant time and care must be taken to measure repeatedly for repeat dose administration. For example, many conventional liquid dispensers may require careful measuring for each dose, which can lead to inaccuracies and time-consuming processes. Thus, the conventional strategy relies on manual measurement. This often causes problems because the conventional strategy does not provide consistent, pre-measured dose volumes. For example, users may need to visually estimate liquid amounts or use separate measuring tools, which can introduce human error. In some cases, dyes are added to increase visibility of a clear liquid within the dispensing device to aid in liquid measurement and dispensing.

Difficulty may arise when a liquid dispenser is used to administer a dose to hard-to-reach areas of a user's body or to another adult, child, infant, or animal either topically or through an orifice. Liquid dispensers of the prior art often require use of two hands for dose administration, and their design often precludes holding the dispenser in certain orientations that may be required to reach hard-to-reach locations. This makes it challenging to deliver a dose confidently and accurately without contaminating nearby skin or surfaces, which leads to unhygienic conditions and undesirable waste.

Leakage and waste of liquids between uses may also be concerns with existing dispensers. Many conventional designs may leave residual liquid in chambers or tubes after dispensing. This can potentially lead to dripping, contamination, or wasted product over time.

Additionally, liquid dispensers of the prior art often incorporate a spring mechanism with substantial shortcomings. In particular, spring mechanisms require more space within the dispenser for compression and decompression, reducing the amount of space available for the liquid/air exchange required to dispense liquid. The spring mechanisms of the prior art often expose the dispensed liquid to spring metal and require significant force to actuate, which poses a particular challenge for one-handed operation.

Liquid dispensers of the prior art often require expensive components or access to electricity. In many but not all settings, liquid dispensers require batteries or a supply of electricity to power expensive pneumatic pumps. These dispensers of the prior art are cost-effective only for certain applications and are of limited use in resource-poor settings.

Additionally, the ability to effectively dispense liquids with different properties may be important in some contexts. Certain conventional dispensers may struggle with very viscous fluids or may not provide consistent results across a range of liquid densities and viscosities. This can potentially restrict their applicability across diverse uses and industries.

Accordingly, there is a need for an affordable liquid dispenser designed to deliver doses of diverse types of liquids accurately, easily, and repeatedly with improved portability, convenience, and overall user experience without expensive components, access to a power source, fluid leakage, and waste.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a portable liquid dispenser may comprise a housing assembly comprising a housing and an adapter connected to the housing. The portable liquid dispenser may include a liquid-containing cartridge removably connected to the adapter. A displacement assembly may be positioned within the housing assembly. The displacement assembly may comprise a compressible chamber having a proximal end and a distal end, a proximal valve connected to the proximal end of the compressible chamber, and a distal valve connected to the distal end of the compressible chamber. A nozzle may be slidably connected to the housing. The displacement assembly may be configured to transition between a first position and a second position to displace a dose volume of liquid from the liquid-containing cartridge through the nozzle.

In other embodiments, a portable liquid dispenser may comprise a housing assembly comprising a housing and an adapter connected to the housing to form an axial bore. The portable liquid dispenser may include a liquid-containing cartridge removably connected to the adapter. A displacement assembly may be positioned within the axial bore of the housing assembly. The displacement assembly may comprise a compressible chamber having a proximal end and a distal end and configured to compress along a central axis, a proximal valve connected to the proximal end of the compressible chamber, and a distal valve connected to the distal end of the compressible chamber. A nozzle may be slidably connected to the housing and configured to compress the displacement assembly along the central axis. Compression of the displacement assembly from a first position to a second position may displace a dose volume of liquid from the liquid-containing cartridge through the nozzle.

In still other embodiments, a portable liquid dispenser may comprise a housing assembly comprising a housing and an adapter connected to the housing. The portable liquid dispenser may include a liquid-containing cartridge removably connected to the adapter. A displacement assembly may be positioned within the housing assembly. The displacement assembly may comprise a compressible chamber having a proximal end, a distal end, and one or more annular ribs around a circumference of an axial bore, a proximal one-way valve connected to the proximal end of the compressible chamber, and a distal one-way valve connected to the distal end of the compressible chamber. An asymmetrical nozzle may be slidably connected to the housing. The nozzle may comprise a dispensing tip and an oppositely positioned grip. The displacement assembly may be configured to transition between a first position and a second position to displace a dose volume of liquid from the liquid-containing cartridge through the dispensing tip of the nozzle.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting explanatory purposes of certain embodiments detailed in the present disclosure. In the drawings:

FIG. 1 is a perspective view of an example of a hand-held liquid dispenser;

FIG. 2A is an exploded perspective view of an example of a container assembly;

FIG. 2B is an exploded perspective view of an example of a housing assembly;

FIG. 3A is a top view of the adapter of FIG. 2B;

FIG. 3B is a top view of the housing of FIG. 2B;

FIG. 4A is an exploded perspective view of an example of a displacement assembly;

FIG. 4B is an exploded perspective view of the displacement assembly of FIG. 4A;

FIG. 5A is a top view of the distal valve of FIG. 4B;

FIG. 5B is a bottom view of the distal valve of FIG. 4B;

FIG. 5C is a top view of the proximal valve of FIG. 4B;

FIG. 5D is a bottom view of the proximal valve of FIG. 4B;

FIG. 6A is a first cross-sectional view of an example of a hand-held liquid dispenser;

FIG. 6B is a second cross-sectional view of an example of a hand-held liquid dispenser; and

FIG. 6C is a third cross-sectional view of an example of a hand-held liquid dispenser.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes to provide a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of a liquid dispensing device, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

In embodiments, a liquid dispenser may have a housing that connects to an adapter to form a housing assembly. The adapter may connect a liquid-containing cartridge to the housing assembly to form a container assembly. A displacement assembly may include proximal and distal valves sealing the ends of a compressible chamber that fits within the housing. A nozzle may be slidably connected to the housing to fully contain the displacement assembly within an axial bore formed by the adapter, housing, and nozzle. In its assembled state, the liquid dispenser comprises a cavity within the displacement assembly, namely the cavity within the compressible chamber axial bore remaining after threading both the distal and proximal valves onto the ends of the compressible chamber, that contains a dose volume.

In its first position, the liquid dispenser comprises the displacement assembly compressed with the minimum amount of force to fully assemble the liquid dispenser. In its second position, the liquid dispenser comprises the displacement assembly compressed maximally. The transition between the first position to the second position generates a pressure differential between the inside of the liquid-containing cartridge and the inside of the compressible chamber that induces displacement and dispensing of the dose volume within the cavity of the displacement assembly. Successive cycling between the first and second positions facilitates accurate repeat dispensing of liquid doses equivalent to the dose volume.

In operation, the liquid dispenser may reduce liquid waste by generating a pressure differential that enables dispensing of all residual liquid from the liquid-containing cartridge and facilitates dispensing of high-viscosity liquids, such as shampoo, oils, and/or the like. The volume of the displacement assembly cavity may determine the dose volume. The compressible chamber cavity may be manufactured in various sizes for specific applications to save valuable time measuring and dispensing the same volume repeatedly. The dispenser design obviates the need for dye additives to aid measuring and dispensing of clear liquids, reducing costs associated with these additives.

The nozzle of such first example embodiment comprises a dispensing tip and a grip. The apparatus design facilitates application of liquid doses when the dispenser is held at any orientation or angle, enabling one-handed use for dose administration topically, orally, rectally, or vaginally in humans or animals. This design requires less manual dexterity and is less prone to user error without compromising delivery of accurate liquid dose volumes throughout successive dispensing cycles. The apparatus described herein eliminates undesirable liquid contact while dispensing hazardous chemicals (e.g., toxic chemicals used in laboratory settings, amine hardeners used with epoxy resins for construction applications, pesticides and herbicides, or any other hazardous chemicals).

The liquid dispenser may be designed for ease of manufacture, assembly, and/or use. The apparatus design, including the design of the displacement assembly and compressible chamber, may help to minimize the number of components, promoting cost-effective manufacturing and assembly. The compressible chamber design helps improve formation of a partial vacuum with fewer superfluous cavities, enabling manufacturing of smaller liquid dispensers with less material consumption and facilitating exchange of liquid and air during operation. The apparatus may be reusable, disposable, and/or composed entirely of biodegradable components.

In some embodiments, the liquid-containing cartridge and adapter may be unitary (e.g., they are one piece and are not replaceable). In other embodiments, the liquid-containing cartridge may be replaced quickly and easily to reuse the dispenser. A nozzle may be reusable or disposable. In some embodiments, the nozzle may be replaced quickly and easily to facilitate hygienic use when the dispenser is shared between multiple users. The liquid-containing cartridge may be stored at any temperature (e.g., cooled for cryotherapy or heated for athletic applications). Components of the liquid dispense, including (but not limited to) the liquid-containing cartridge and/or the housing, may be fabricated from an opaque material to prevent degradation of photosensitive compounds, including (as non-limiting examples) cannabidiol (CBD), tetrahydrocannabinol (THC), betamethasone, and/or other compounds. Connections between components may be airtight to help preserve the integrity and shelf life of the liquid stored within and dispensed by the apparatus. Liquids stored within and dispensed by the apparatus may include formulations with active ingredients to treat diverse indications, including ingredients to relieve pain through cooling and/or warming sensations.

In some embodiments, one or more components of the liquid dispenser may be manufactured from silicone, a low-taint, non-toxic material more robust than glass for various liquid dispensing applications. Alternative embodiments may be manufactured from other elastomers, including food-grade silicone and/or silicone rubbers, and/or polymers, including polycarbonate, high-density polyethylene, low-density polyethylene, polyethylene terephthalate, polypropylene, and/or high impact polystyrene.

In some embodiments, the components of the liquid dispenser may vary in shape and/or size to modulate fluid dynamics, including (but not limited to) rate of flow, direction, shape, mass, or pressure, and/or to enable use with fluids of varying viscosities and densities for diverse applications.

In some embodiments, the liquid dispenser may allow for efficient and accurate dose dispensing in various settings, including for laboratory, medical, veterinary, or construction applications. The dispenser may improve convenience and overall user experience, and/or may reduce spillage and/or waste.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

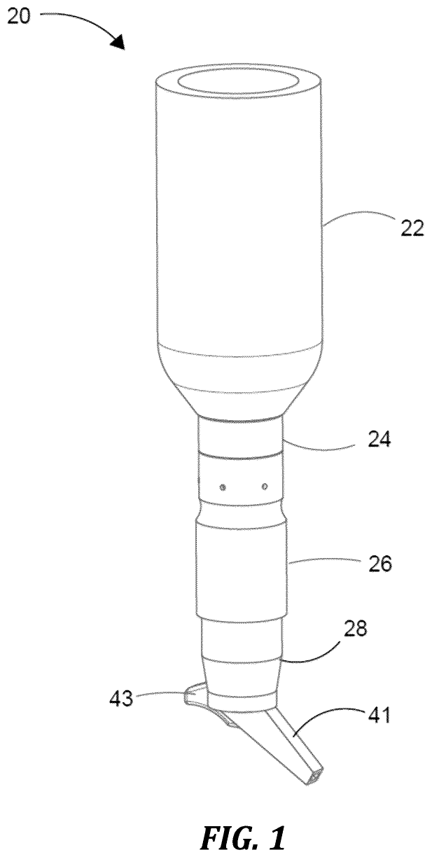

FIG. 1 shows an example embodiment of liquid dispenser 20 fully assembled with a liquid-containing cartridge 22 connected to an adapter 24. The adapter 24 may be connected to a housing 26, and the housing 26 may be connected to a nozzle 28. This example embodiment includes an asymmetrical nozzle 28, which may have a dispensing tip 41 to direct the flow of fluid. An oppositely positioned grip 43 allows for ergonomic gripping and actuation of the dispenser 20.

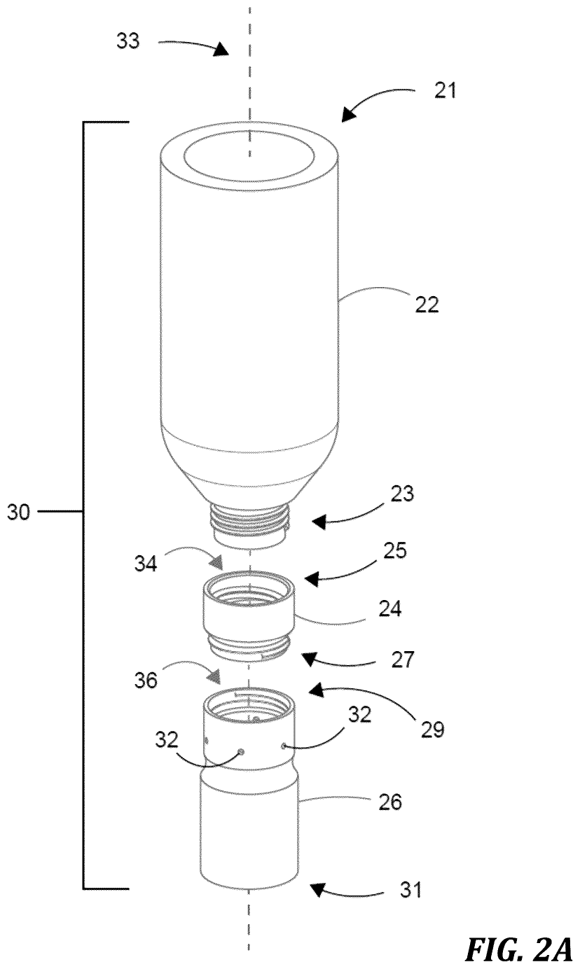

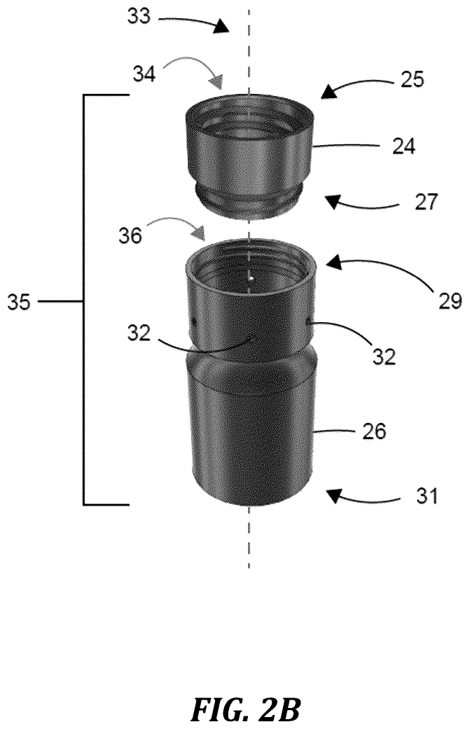

As depicted in an exploded view of an example embodiment in FIG. 2A, the liquid dispenser 20 includes a container assembly 30 having a liquid-containing cartridge 22, an adapter 24, and a housing 26. The liquid-containing cartridge 22 has a proximal end 23 and a distal end 21. The proximal end 23 of the liquid-containing cartridge 22 may be removably connected to a distal end 25 of adapter 24. A proximal end 27 of adapter 24 may be removably connected to the distal end 29 of housing 26. A central axis 33 passes through points defined by the cartridge distal end 21 and the housing proximal end 31, through the approximate center of each of the liquid-containing cartridge 22, the adapter 24, and the housing 26.

Connections between the liquid-containing cartridge 22, the adapter 24, and the housing 26 may provide a fluid tight seal between the components. As one example, at least one of the connections may be a tapered threaded connection. Alternative embodiments anticipated herein may exhibit alternative threading, including straight threads requiring a soft seal such as an O-ring, gasket, or flat washer and varied thread parameters, including varied flank angles and either flat or rounded truncations of the thread root and crest. In other embodiments a non-threaded fluid-tight connection may be used for at least one of the connections.

As depicted in FIGS. 2A and 2B, the cartridge proximal end 23 and the adapter proximal end 27 each have male threaded ends and the adapter distal end 25 and the housing distal end 29 each have female threaded ends to receive the corresponding male threaded ends. Alternative embodiments anticipated herein may exhibit alternative male and female threaded end connections, including female threaded ends for the cartridge proximal end 23 and the adapter proximal end 27 and corresponding male threaded ends for the adapter distal end 25 and the housing distal end 29, as well as combinations thereof.

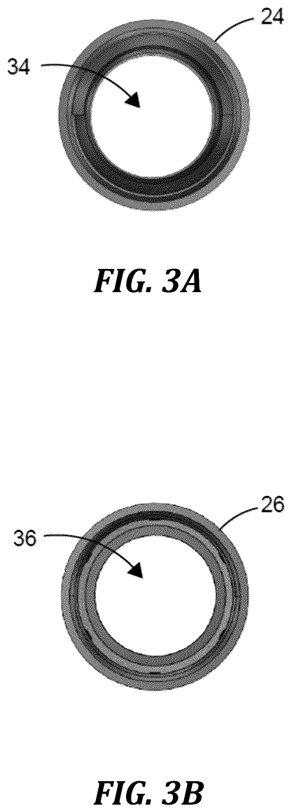

Referring now to FIGS. 2B, 3A, and 3B, a housing assembly 35 may include an adapter 24 connected to housing 26. An axially extending bore within the housing assembly 35 may include an adapter axial bore 34 and a housing axial bore 36. The housing 26 may include one or more air holes 32 disposed around the circumference of the housing to permit exchange of air between the interior and the exterior of the housing. This exchange of air may help to prevent accumulation of air pressure within the liquid dispenser during operation.

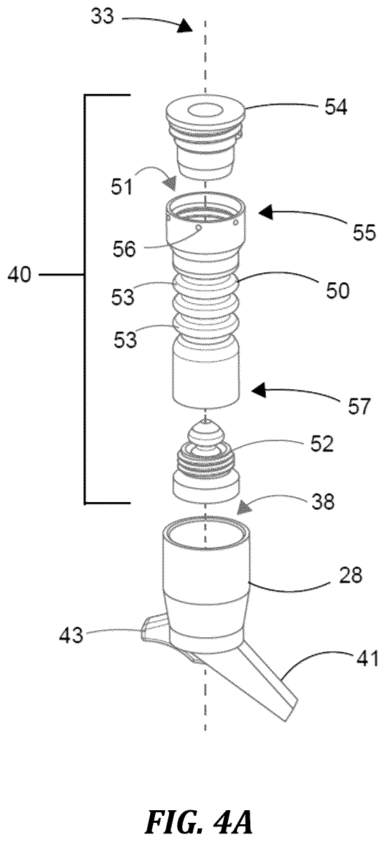

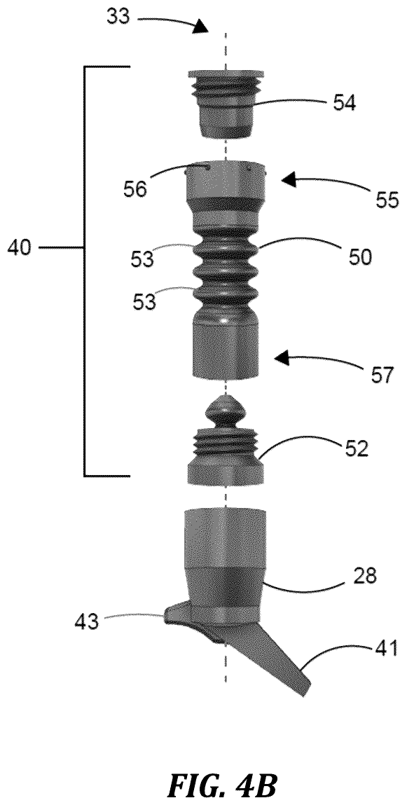

As shown in at least FIGS. 4A and 4B, a displacement assembly 40 may include a distal valve 54 removably connected to a distal end 55 of compressible chamber 50, and a proximal valve 52 removably connected to the proximal end 57 of compressible chamber 50. The compressible chamber 50 may be compressed as force is applied along the central axis 33, through the axial bore 51. In some embodiments, the compressible chamber 50 may be formed from a relatively flexible lightweight material. In some embodiments, the compressible chamber 50 may comprise one or more annular ribs 53 disposed around the circumference of the compressible chamber. For example, the one or more ribs 53 may be disposed about an axial bore 51 of the compressible chamber 50. Each of the one or more annular ribs 53 may occupy a plane that is generally perpendicular to the central axis 33. Planes of the one or more annular ribs are generally parallel to each other. The distal end 55 of the compressible chamber 50 may include at least one protrusion 56. The one or more protrusions 56 may be disposed around the circumference of the compressible chamber 50 to help facilitate a tight fit of displacement assembly 40 within the housing 26.

In alternative embodiments, the compressible chamber may have varying parameters, including varied outer diameter, inner diameter, mean diameter, free length, volume, solid height, and material. Alternative embodiments may include annular ribs with varying parameters, including size, shape, height, and curvature. Alternative embodiments may also include one continuous, helical or spring-like rib spiraling around the central axis 33 instead of or in addition to the one or more annular ribs 53. The continuous, spring-like rib may exhibit varying parameters, including varied index, number of active coils, pitch, rate, and handedness. In some alternative embodiments, the protrusions 56 may have varying size and/or shape to help control the fit of the displacement assembly 40 within the housing 26. At least one of the one or more protrusions 56 may include a hole or valve to facilitate air exchange. The compressible chamber 50 may include a line, indentation, and/or protrusion indicating a volume below which accurate dispensing is compromised. In some embodiments, the compressible chamber 50 may be manufactured from silicone or other elastomers, including food-grade silicone and silicone rubbers.

The dispenser 20 may include a removable connection between the distal valve 54 and compressible chamber 50, and/or between the proximal valve 52 and the compressible chamber. The connection may provide a fluid-tight seal. For example, in some embodiments, the removable connections may comprise tapered threaded connections providing a fluid tight seal. In alternative embodiments, alternative threading may be used, including (but not limited to) straight threads requiring a soft seal such as an O-ring, gasket, and/or flat washer and varied thread parameters, including varied flank angles and either flat or rounded truncations of the thread root and crest. As shown in FIGS. 4A and 4B, both the distal valve 54 and the proximal valve 52 have male threaded ends and both the distal end 55 and the proximal end 57 of compressible chamber 50 have female threaded end connections to receive the corresponding male threaded ends. Alternative embodiments anticipated herein may exhibit alternative male and female threaded end connections. Alternative embodiments may have female and male threaded end connections of various sizes and shapes, where the diameters of each component may be modulated to control the rate of flow, direction, shape, mass, or pressure of the fluid stream emerging from the cartridge, passing through the adapter into the housing, or passing through the displacement assembly.

Alternative embodiments may integrate one or more of the proximal and distal valves directly into the compressible chamber, leaving a space, either annular or any other shape, between the valve and the compressible chamber to permit ingress and egress of air from one or more small holes in the compressible chamber to equilibrate air pressure. Alternative embodiments may include fewer than two valves. As one example, an embodiment may include only the proximal valve, or only the distal valve. Alternative embodiments may include more than two valves. For example, three or more valves in series may be used to modulate the rate of flow, direction, shape, mass or pressure of the fluid stream emerging from the cartridge, passing through the adapter into the housing, or passing through the displacement assembly.

The nozzle 28 may be slidably connected to the housing 26. The nozzle 28 may include an axial bore 38, which may receive the compressible chamber proximal end 57 where compressible chamber 50 is connected to the proximal valve 52. The nozzle 28 may have a distal end 37 configured to fit into the housing proximal end 31. The central axis 33 may pass through the center of one or more (e.g., each) of the distal valve 54, the compressible chamber 50, the proximal valve 52, and the nozzle bore 38. Alternative embodiments may include alternative means of connection between nozzle 28 and the housing 26, including threaded or otherwise interlocking connections, to facilitate alignment of the components, prevent inadvertent disconnection, and/or permit locking to prevent undesired liquid dispensing.

As shown in FIGS. 1, 4A, 4B, 6A, and 6B, the nozzle 28 may be asymmetrical. The asymmetrical design may include a dispensing tip 41 configured to direct the flow of fluid, and an oppositely positioned grip 43. The grip 43 may include a projection by which the nozzle is held firmly in place and by which force is applied to operate the liquid dispenser 20. In some embodiments, the dispensing tip 41 and grip 43 may be designed to facilitate ease of liquid dispensing with one hand. Alternative embodiments may exhibit grips of diverse sizes, shapes, materials, coatings, textures, and/or quantities to modulate the pressure and angle by which the nozzle 28 is held in place and force is applied to meet the needs of various applications. Nozzles 28 and/or dispensing tips 41 of diverse sizes, shapes, materials, coatings, and textures may be used to modulate or adjust the rate of flow, direction, shape, mass, and/or pressure of the fluid stream emerging from the dispensing tip 41 to meet the needs of various applications. Alternative embodiments may include a nozzle 28 having a collapsible, telescoping, retracting, and/or folding grip 43. In some embodiments, the nozzle 28 may incorporate a collapsible, telescoping, retractable, folding, rotating, extendable, locking, or closable dispensing tip 41. Such a dispensing tip 41 and/or grip 43 may help to enhance portability, reach, and/or accuracy of the apparatus or temporarily disable liquid dispensing. Alternative embodiments may include a symmetrical nozzle 28, a finger hole through the nozzle or other component to serve as a grip 43. In some embodiments, components including (but not limited to) the liquid-containing cartridge 22, the housing 26, and/or the nozzle 28, may be designed with smooth edges to help reduce or prevent snagging and/or accidental liquid dispensing, and/or to facilitate comfortable one-handed operation.

In some embodiments, the nozzle 28 may be adapted for the specific use of the liquid dispenser 20. As a specific example, when the liquid dispenser 20 is for use with pets, the nozzle 28 may include an elongated dispensing tip 41 to facilitate dispersal of the liquid for a longer head shape. The nozzle 28 may further include components formed from different materials. For example, when the liquid dispenser 20 is intended for use on another being, and particularly in children (e.g., infants or toddlers) or animals who may be relatively smaller and more prone to injury when compared to an adult human, the dispensing tip 41 may be formed from a softer silicone-like material to help prevent injuries.

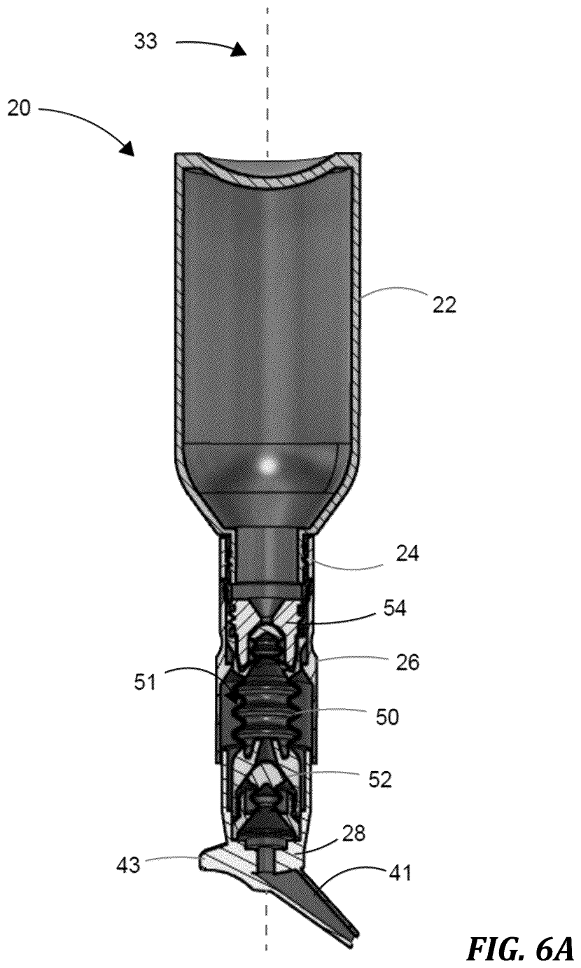

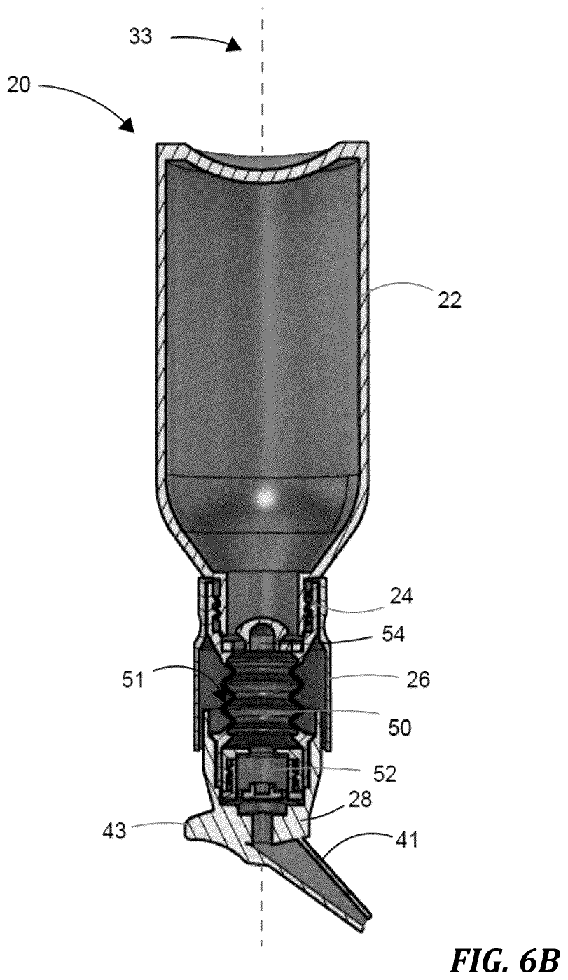

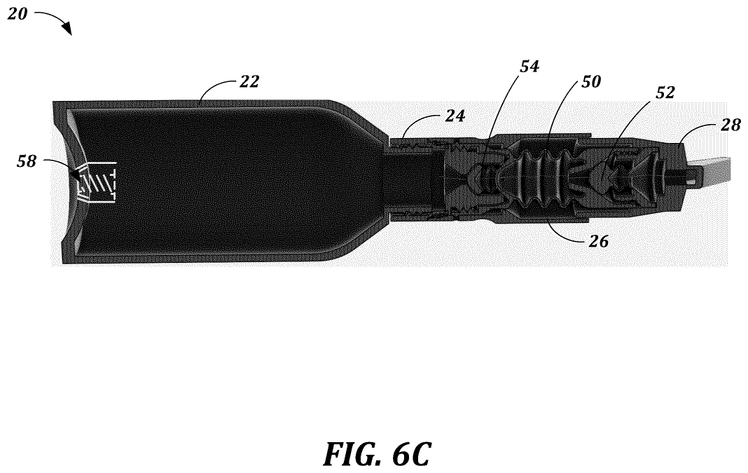

In some embodiments, as shown in FIG. 6C, a third valve 58 may be positioned within the liquid containing cartridge 22. For example, the third valve 58 may be disposed at or near the cartridge distal end 21. The third valve 58 may allow for air to enter the cartridge 22, replacing a volume of liquid that leaves the cartridge (e.g., into the chamber 50). In this way, pressure within the cartridge 22 may remain substantially constant, even as the liquid contents of the cartridge is dispensed, improving the accuracy of the dispensed dosages and allowing for additional doses to be dispensed from a single cartridge before it becomes unusable. In some embodiments, the third valve 58 may incorporate a filter to prevent airborne contaminants from entering the cartridge 22.

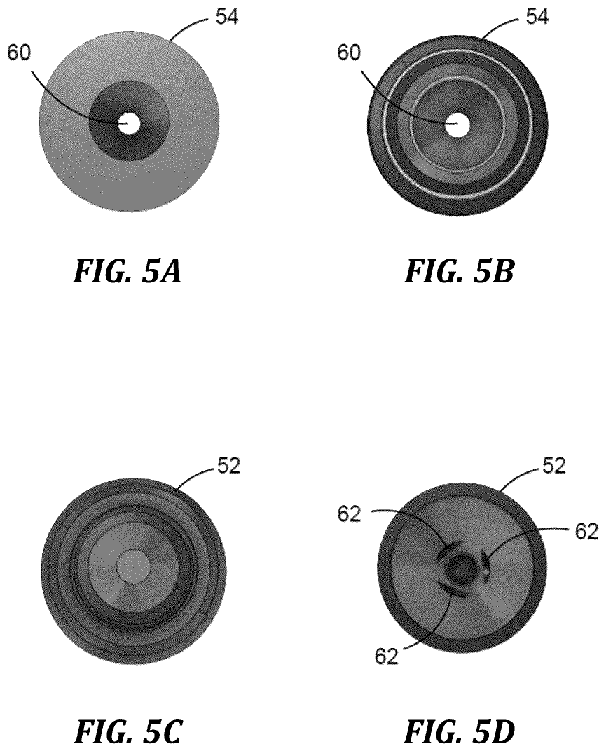

Referring to FIGS. 5A and 5B, the distal valve 54 is depicted from top and bottom views, respectively. Referring to FIGS. 5C and 5D, the proximal valve 52 is depicted from top and bottom views, respectively. In some embodiments, the distal valve 54, the proximal valve 52, and/or the third valve 58 may be formed as one-way valves, helping to ensure unidirectional fluid flow and prevent fluid leakage. As one specific example, the proximal valve 52, the distal valve 54, and/or the third valve 58 may be an umbrella valve, having a diaphragm that functions as a check valve. Alternatively, the proximal valve 52, the distal valve 54, and/or the third valve 58 may be formed as umbrella valves with diaphragms of different shapes, sizes, and/or installation methods, including (but not limited to) pull-in and push-in valves; ball valves, including (but not limited to) contoured V-port ball valves having varied angles and percentage flow characteristics, varied actuator sizes within valves, and varied ball rotations; and/or any other check valve that may be usable to help enforce a unidirectional flow of liquid.

As depicted in the embodiment shown in FIGS. 4A and 4B, the distal valve 54 is cylindrical, and the proximal valve 52 tapers to a bell shape. As depicted in FIGS. 5A and 5B, distal valve 54 includes one aperture. As depicted in FIGS. 5C and 5D, the proximal valve 52 includes a plurality of apertures. Alternative embodiments anticipated herein may exhibit distal and proximal valves and diaphragms of varying shapes and sizes with one or more apertures to modulate the rate of flow, direction, shape, mass, or pressure of the fluid stream entering or exiting the compressible chamber.

As shown in FIGS. 6A and 6B, embodiments of the liquid dispenser 20, may be fully assembled with the liquid-containing cartridge 22 removably connected to adapter 24. The adapter 24 may be removably connected to the housing 26, The nozzle 28 may be slidably connected to the housing 26. The displacement assembly 40 (as depicted in FIGS. 4A and 4B) may be fully assembled within the axial bore formed by the adapter axial bore 34, housing axial bore 36, and nozzle axial bore 38. In its fully assembled state, the displacement assembly 40 comprises the distal valve 54 threaded onto the compressible chamber distal end 55 and the proximal valve 52 threaded onto the compressible chamber proximal end 57, forming a sealed cavity within the compressible chamber 50 to prevent fluid leakage from the cavity within displacement assembly 40. All components of the liquid dispenser 20 may be sealingly engaged with each other to provide an airtight and/or fluid-tight seal. The central axis 33 passes through the center of one or more (e.g., each) of the liquid-containing cartridge 22, adapter 24, housing 26, distal valve 54, compressible chamber 50, proximal valve 52, and nozzle axial bore 38.

In a first position, as depicted in FIGS. 6A and 6B, the liquid dispenser 20 has the displacement assembly 40 (e.g., comprising the distal valve 54, compressible chamber 50, and proximal valve 52) compressed with the minimum amount of force to fully assemble the liquid dispenser. In a second position, the liquid dispenser 20 may have the nozzle 28 fully displaced along central axis 33 toward the cartridge distal end 21, compressing compressible chamber 50 maximally given component parameters. Components of the liquid dispenser 20 are fitted together to facilitate compression of compressible chamber 50 like an accordion to enable smooth transition from the first position to the second position when force is applied to the nozzle 28 toward the cartridge distal end 21 along central axis 33, as well as smooth transition from the second position to the first position when said force is removed. The accordion-like compression and decompression of compressible chamber 50 between the first position and second position requires minimal force, increasing accuracy and decreasing potential for user error. The compression of the compressible chamber 50 facilitates improved pressure differential formation between cavities, and concomitant improved formation of a partial vacuum to enable dispensing of viscous liquids. Incorporation of proximal valve 52 and distal valve 54 into displacement assembly 40 also facilitates improved pressure differential between cavities of the liquid dispenser and concomitant improved formation of a partial vacuum to enable dispensing of viscous liquids. Intermediate positions between the first and second positions are transited as the compressible chamber 50 compresses or decompresses along a distance.

When the dispenser is fully assembled with a liquid-containing cartridge 22 installed, prior to operation the liquid dispenser is in the first position and the compressible chamber axial bore 51 contains air. The dose volume of liquid to be administered is determined based on the volume of the cavity within displacement assembly 40, namely the cavity within the compressible chamber axial bore 51 remaining after threading the distal valve 54 onto the compressible chamber distal end 55 and threading the proximal valve 52 onto the compressible chamber proximal end 57.

Operation of the liquid dispenser includes applying a force to the nozzle 28 (e.g., via the grip 43). Application of this force causes the nozzle 28 to move toward the cartridge distal end 21 along central axis 33, expelling the contents of the cavity of displacement assembly 40 through the one or more proximal valve apertures 62 and out dispensing tip 41, transitioning the liquid dispenser partially or fully from the first position to the second position. In embodiments, the axial bore 41 helps to maintain axial alignment of the liquid dispenser 20 along the central axis 33 as nozzle 28 moves toward the cartridge distal end 21, compressing the compressible chamber 50.

When the force is subsequently removed, the liquid dispenser transitions back to the first position and the pressure differential between the inside of liquid-containing cartridge 22 and the cavity of displacement assembly 40 generates a partial vacuum. The partial vacuum may impart a force on the one-way valve sufficient to both fill the entire dose volume of the cavity within displacement assembly 40 with liquid and displace the entire dose volume of liquid through the one or more proximal valve apertures 62 and out dispensing tip 41 when force is applied to transition the liquid dispenser fully between the first position and the second position. When force is subsequently removed, the liquid dispenser transitions back to the first position and the pressure differential between the inside of liquid-containing cartridge 22 and the inside of compressible chamber 50 maintains a partial vacuum without liquid remaining in the compressible chamber. Successive dispensing cycles are accomplished by alternating between the first and second positions (or between intermediate positions between the first and second positions) by application and removal of force to the nozzle 28 toward the cartridge distal end 21 along central axis 33. When sufficient force is applied and removed to alternate between the first position and the second position, the entire dose volume of the cavity within displacement assembly 40 is dispensed, leading to accurate successive dispensing of liquid doses. Alternative embodiments include means for varying the dose volume of the cavity within the displacement assembly, including a switch or dial mechanism to toggle between one or more volumes.

In operation, the liquid dispenser expels accurate doses of liquid throughout successive dispensing cycles since the at least one air hole arrayed around the circumference of the housing permits exchange of air between the interior and the exterior of the housing to prevent accumulation of air pressure within the liquid dispenser. Alternative embodiments include air holes in the at least one protrusion arrayed around the circumference of the compressible chamber to permit exchange of air and prevent accumulation of air pressure, or to permit air exchange within a cavity within the housing. For example, an alternative embodiment may include a cavity within the housing with sufficient volume to enable exchange of air entirely within the liquid dispenser, obviating the requirement for air exchange between internal cavities of the liquid dispenser and the external environment. Alternative embodiments include designs for which liquid remains in the compressible chamber when the liquid dispenser is in the first position.

It will be appreciated that the liquid dispenser may be used in conjunction with computerized systems, including for chilling or heating the liquid-containing cartridge, the liquid, or other components of the liquid dispenser. Other computerized systems may include electronic assistance, for example for volumetric measurement, and may include a peristaltic pump, a plunger-like compensator, or a lancing apparatus.

Alternative embodiments may include incorporation of the liquid dispenser 20 into other systems, including containment vessels such as bottles, carboys, cardboard packaging for liquids, and any other vessel for liquid containment. In an example embodiment incorporating the liquid dispenser into a bottle, the compressible chamber 40 may be fit inside a bottle cap and filled with liquid. A distal valve is located between the compressible chamber 40 and the exterior of the bottle cap, and a proximal valve is located between the compressible chamber and the internal cavity of the bottle. In a liquid dispenser second position, a displacement assembly comprising the distal valve, compressible chamber, and proximal valve is compressed and the liquid dose volume is pre-loaded into the compressible chamber. In a liquid dispenser first position, the compressible chamber is decompressed maximally given component parameters. When the liquid dispenser transitions fully from the second position to the first position, the entire dose volume of liquid dispenses through one or more proximal valve apertures and into the internal cavity of the bottle. This transition may be accomplished by means of a grip or button on the bottle cap and may facilitate removal of the bottle cap and simultaneous liquid dispensing. Alternative embodiments include alternative means of transitioning the liquid dispenser from the second position to the first position, including twisting a threaded cap to both decompress the compressible chamber, thereby dispensing the dose volume into the bottle as a result of the partial vacuum, and remove the cap from the bottle.

Some embodiments may include a manual dose tallying or tracking mechanism such as (but not limited to) a transparent window, a mechanical dose counting mechanism, or any other mechanism to count or track a number of doses administered and/or a number of doses remaining in the cartridge 22. Additionally or alternatively, digital computers, capacitive sensors, and displays may be applied for real-time monitoring, data communication, and dosage tallying.

### III. Platform Operation

Embodiments of the present disclosure provide a system operative by a set of methods. The following depicts an example of at least one method of a plurality of methods that may be performed by at least one of the aforementioned system. Various components may be used at the various stages of operations disclosed.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method. The method may comprise the following stages:

In general, a method of using the apparatus may include assembling the liquid dispenser by providing housing and displacement assemblies and connecting a liquid-containing cartridge to the assembled housing and displacement assemblies.

The method may include grasping the housing assembly with a hand and gripping the nozzle grip with a finger, for example the thumb, of said hand and applying force to the nozzle in the direction of the cartridge distal end.

The method may include applying sufficient force to the nozzle to transition the liquid dispenser from the first position to the second position, expelling air from the nozzle dispensing tip. The method may include removing applied force to transition the liquid dispenser from the second position to the first position, generating a pressure differential within cavities of the liquid dispenser and a concomitant partial vacuum.

The method may include applying sufficient force to the nozzle to transition the liquid dispenser from the first position to the second position, filling the displacement assembly with a dose volume of liquid from the liquid-containing cartridge and expelling the dose volume of liquid from the nozzle dispensing tip.

The method may include alternating between the first and second positions repeatedly to deliver repeat dose volumes. The method may include replacing the liquid-containing cartridge or replacing the nozzle.

In some embodiments, the method may include manual dose tallying such as (but not limited to) the use of a transparent window or a mechanical dose counting mechanism to track a number of doses administered and/or a number of doses remaining in a cartridge. Additionally or alternatively, digital computers, capacitive sensors, and displays may be applied for real-time monitoring, data communication, and dosage tallying.

The following is claimed:

1. A portable liquid dispenser comprising:
a housing assembly comprising a housing and an adapter connected to the housing;
a liquid-containing cartridge removably connected to the adapter;
a displacement assembly positioned within the housing assembly, the displacement assembly comprising:
a compressible chamber formed from a flexible material, the compressible chamber having a proximal end and a distal end,
a proximal valve connected to the proximal end of the compressible chamber, and
a distal valve connected to the distal end of the compressible chamber; and
a nozzle slidably connected to the housing,
wherein the displacement assembly is configured to transition between a first position and a second position to displace a dose volume of liquid from the liquid-containing cartridge through the nozzle.

2. The portable liquid dispenser of claim 1, wherein the compressible chamber comprises one or more annular ribs around a circumference of an axial bore of the compressible chamber.

3. The portable liquid dispenser of claim 1, wherein the compressible chamber comprises at least one protrusion arrayed around a circumference of the compressible chamber to facilitate a tight fit of the displacement assembly within the housing.

4. The portable liquid dispenser of claim 1, wherein the housing comprises at least one air hole arrayed around a circumference of the housing to permit exchange of air between an interior and an exterior of the housing.

5. The portable liquid dispenser of claim 1, wherein the nozzle comprises a dispensing tip and a grip.

6. The portable liquid dispenser of claim 5, wherein the nozzle is asymmetrical to provide the dispensing tip to direct a flow of fluid and the grip oppositely positioned from the dispensing tip.

7. The portable liquid dispenser of claim 1, wherein the proximal valve and the distal valve are one-way valves.

8. The portable liquid dispenser of claim 7, wherein the proximal valve and the distal valve are umbrella valves.

9. The portable liquid dispenser of claim 1, wherein the proximal valve comprises more than one aperture.

10. The portable liquid dispenser of claim 1, wherein the distal valve comprises one aperture.

11. The portable liquid dispenser of claim 1, wherein a connection between the liquid-containing cartridge and the adapter, and a connection between the adapter and the housing are each fluid tight, comprising one or more of the following:
a tapered threaded connection,
an O-ring, or
a gasket.

12. The portable liquid dispenser of claim 1, wherein the nozzle comprises an elongated dispensing tip.

13. A portable liquid dispenser comprising:
a housing assembly comprising a housing and an adapter connected to the housing to form an axial bore;
a liquid-containing cartridge removably connected to the adapter;
a displacement assembly positioned within the axial bore of the housing assembly, the displacement assembly comprising:
a compressible chamber having a proximal end and a distal end and configured to compress along a central axis, wherein the axial bore of the housing assembly maintains the axial alignment of the portable dispenser during the compression,
a proximal valve connected to the proximal end of the compressible chamber, and
a distal valve connected to the distal end of the compressible chamber; and
a nozzle slidably connected to the housing and configured to compress the displacement assembly along the central axis,
wherein compression of the displacement assembly from a first position to a second position displaces a dose volume of liquid from the liquid-containing cartridge through the nozzle.

14. The portable liquid dispenser of claim 13, wherein the compressible chamber comprises one or more annular ribs around a circumference of an axial bore of the compressible chamber, each of the one or more annular ribs occupying a plane perpendicular to the central axis.

15. The portable liquid dispenser of claim 13, wherein the housing comprises at least one air hole arrayed around a circumference of the housing to permit exchange of air between an interior and an exterior of the housing.

16. The portable liquid dispenser of claim 13, wherein the nozzle comprises an asymmetrical design providing a dispensing tip to direct a flow of fluid and an ergonomic grip oppositely positioned from the dispensing tip.

17. The portable liquid dispenser of claim 13, wherein the proximal valve and the distal valve are one-way umbrella valves.

18. A portable liquid dispenser comprising:
a housing assembly comprising a housing and an adapter connected to the housing;
a liquid-containing cartridge removably connected to the adapter;
a displacement assembly positioned within the housing assembly, the displacement assembly comprising:
a compressible chamber having a proximal end, a distal end, and one or more annular ribs around a circumference of an axial bore,
a proximal one-way valve connected to the proximal end of the compressible chamber, and
a distal one-way valve connected to the distal end of the compressible chamber; and
an asymmetrical nozzle slidably connected to the housing, the nozzle comprising a dispensing tip and an oppositely positioned grip,
wherein the displacement assembly is configured to transition between a first position and a second position to displace a dose volume of liquid from the liquid-containing cartridge through the dispensing tip of the nozzle.

19. The portable liquid dispenser of claim 18, wherein the housing comprises at least one air hole arrayed around a circumference of the housing to permit exchange of air between an interior and an exterior of the housing.

20. The portable liquid dispenser of claim 18, wherein connections between the liquid-containing cartridge, the adapter, and the housing are tapered threaded connections providing a fluid tight seal.
